(19) United States
(12) Patent Application Publication
(10) Pub. No.: US 2015/0038203 A1
(43) Pub. Date: Feb. 5, 2015

(54) SYSTEM AND METHOD FOR PROVIDING BALL GAME

(71) Applicant: GOLFZON CO., LTD., Daejeon (KR)

(72) Inventor: Kyu-ha Cho, Seoul (KR)

(73) Assignee: GOLFZON CO., LTD., Daejeon (KR)

(21) Appl. No.: 14/374,208

(22) PCT Filed: Jan. 25, 2013
(86) PCT No.: PCT/KR2013/000645

§ 371 Date: Jul. 23, 2014

(30) Foreign Application Priority Data
Jan. 27, 2012 (KR) 10-2012-0008511

(51) Int. Cl. A63F 13/573; A63F 13/812; G06F 3/0481

(52) U.S. Cl. CPC A63F 13/573; G06F 3/04817; A63F 13/812
USPC 463/3

(57) ABSTRACT

Disclosed herein are a method and apparatus of providing a ball game. In the method, an available hitting area for enabling the input of a hitting point is displayed in the form of a rotation animation that dynamically rotates the available hitting area in the estimated direction of rotation of the ball based on the location of the hitting point. An impact icon for enabling the determination of impact is displayed in the form of a variation animation that dynamically varies the impact icon. If an input indicative of the stopping of the variation of the impact icon has been received, an impact value is determined based on the impact icon whose variation has been stopped at the time at which the input indicative of the stopping is received. The ball is moved across the virtual space based on the input hitting point and the impact value.

### TECHNICAL FIELD

The present invention relates, in general, to a system and method for providing a ball game and, more particularly, to a system and method for providing a ball game that are capable of providing a swing interface that enables a player to easily manipulate it.

### BACKGROUND ART

With the ongoing development of electronic terminals, a variety of types of content can be provided and enjoyed using such electronic terminals. Accordingly, a plurality of users enjoy on-line games using electronic terminals, and game providers that provide such on-line games also produce content closely related to the real lives of users in the form of games, and then provide the games to the users in order to provide interesting game content to the users.

In particular, one type of game content that has recently attracted interest is sports-related content. Of a variety of types of sport content, ball games, such as golf, baseball or billiards, have attracted great interest.

When ball game sports are implemented in the form of games, the implemented ball games are characterized in that a character that is controlled by a user hits a ball. That is, victory or defeat in a ball game is mostly determined depending on whether a user can accurately hit a ball to a desired distance in a desired direction. For example, when golf is implemented in the form of a game and then provided to a player, a golf ball should be moved to a desired distance in a desired direction in order for the player to win the golf game or acquire points, in which case the player needs to finely set a hitting point and the strength of hitting.

Meanwhile, current game interfaces enable only simple manipulation, and are not intuitively understood by users. That is, there is a need for a swing interface that enables a user to easily perform swing manipulation in a ball game and that can be intuitively understood by the user without requiring separate learning time and efforts.

### DISCLOSURE OF INVENTION

### Technical Problem

Accordingly, the present invention has been made keeping in mind the above problems occurring in the prior art, and the present invention is intended to provide a system and method for providing a ball game.

to a player who plays a ball game.

Moreover, the present invention is intended to provide a player who plays a ball game with a swing interface that enables fine manipulation.

### Solution to Problem

The present invention is directed to a system and method for providing a ball game.

In accordance with an aspect of the present invention, there is provided a method of providing a ball game that provides a ball in virtual space and then allows the ball to be hit, including displaying an available hitting area for enabling the input of a hitting point in the form of a rotation animation that dynamically rotates the available hitting area in the estimated direction of rotation of the ball based on the location of the hitting point in the available hitting area, displaying an impact icon for enabling the determination of impact in the form of a variation animation that dynamically varies the impact icon, if an input indicative of the stopping of the variation of the impact icon has been received, determining an impact value based on the impact icon whose variation has been stopped at the time at which the input indicative of the stopping of the variation of the impact icon is received, and moving the ball across the virtual space based on the input hitting point and the impact value.

In accordance with another aspect of the present invention, there is provided a system for providing a ball game that provides a ball in virtual space and then allows the ball to be hit, including a hitting point determination unit configured to display an available hitting area for enabling the input of a hitting point in the form of a rotation animation that dynamically rotates the available hitting area in the estimated direction of rotation of the ball based on the location of the hitting point in the available hitting area, an impact determination unit configured to display an impact icon for enabling the determination of impact in the form of a variation animation that dynamically varies the impact icon, and to, if an input indicative of the stopping of the variation of the impact icon has been received, determine an impact value based on the impact icon whose variation has been stopped at the time at which the input indicative of the stopping of the variation of the impact icon is received, and a swing result processing unit configured to move the ball across the virtual space based on the input hitting point and the impact value.

### Advantageous Effects of Invention

In accordance with an embodiment of the present invention, there is provided a system and method for providing a ball game.

Furthermore, in accordance with an embodiment of the present invention, an intuitive swing interface is provided to a player who plays a ball game, and thus the immersion of the player in a game can be increased.

Moreover, in accordance with an embodiment of the present invention, a swing interface capable of fine manipulation is provided to a player who plays a ball game, thereby maximizing the interest of the player in the game. As a result, existing players can be prevented from leaving the game, and also new players can be easily attracted.

The advantages that can be obtained from the present invention are not limited to the above-described advantages, and other advantages that have not been described above will be clearly understood from the following description by those having ordinary knowledge in the art to which the present invention pertains.

### BRIEF DESCRIPTION OF DRAWINGS

The above and other objects, features and advantages of the present invention will be more clearly understood from the following detailed description taken in conjunction with the accompanying drawings, in which:

FIG. 1 is a schematic block diagram of a system for providing a ball game in accordance with an embodiment of the present invention;

FIG. 2 is a flowchart illustrating a method of providing a ball game in accordance with an embodiment of the present invention;

FIG. 3 is a diagram illustrating a situation prior to a swing interface being provided via the screen of a terminal in which a game client has been installed, in accordance with the embodiments of the present invention; and

FIGS. 4 and 7 are diagrams illustrating examples of a swing interface provided via the screen of a terminal in which a game client has been installed, in accordance with the embodiments of the present invention.

### MODE FOR THE INVENTION

The present invention is not limited to the following embodiments, but may be implemented in a variety of ways. The following embodiments are provided merely to make the disclosure of the present invention complete and to notify those having ordinary knowledge in the art to which the present invention pertains of the scope of the present invention. The scope of the present invention is defined only by the following claims.

Throughout the drawings, like reference symbols denote like components.

A system and method for providing a ball game in accordance with embodiments of the present invention will be described in detail below with reference to the accompanying drawings.

Prior to the following description, the meanings of the terms that will be used in the following description are defined below.

In the following description, the term “character” is a fictional character that appears in the virtual space of a game, and is an object that is controlled by a player and an agent that performs game operation. The character is visualized in the form of a two-dimensional (2D) or three-dimensional (3D) character image, and is defined by various attributes. For example, operations that can be performed by the character in a golf game may vary depending on the level (a value indicative of the level of cumulative empirical values that are obtained when the character plays a game) of the character, or depending on the stance (the locations of two feet of the character or the width between the two feet at the time at which the player takes a swing to hit a golf ball in a golf game) of the character.

The term “item” is a virtual object in virtual space that is related to the playing of a game of the character, and includes, for example, the clothes or accessory of the character with which the appearance of the character is decorated, or the clothes, accessory or tool which increases the level of the character. For example, an item of a golf game may be a golf club, and the maximum strength value of hitting that can be applied by the character may vary depending on a golf club that is used when the character takes a swing.

The terms requiring descriptions, other than the terms defined above, will be separately given in the following description.

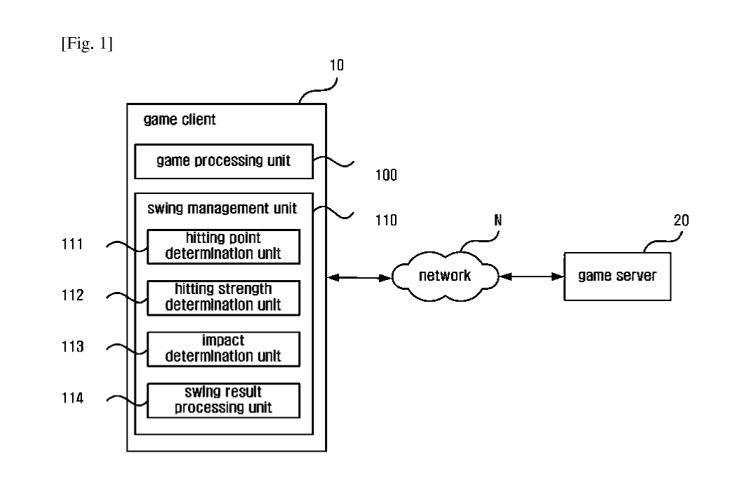

FIG. 1 is a schematic block diagram of a system for providing a ball game in accordance with an embodiment of the present invention.

The system for providing a ball game is a system that provides a ball game in which a player controls a character so that the character hits a ball that is used in the ball game.

As illustrated in FIG. 1, the system for providing a ball game includes a game client 10 and a game server 20, and enables the game client 10 and the game server 20 to communicate with each other over a wired or wireless network N. Although there may be a plurality of game clients that communicate with the game server 20, a single game client will be described below for ease of description.

The game client 10 in accordance with this embodiment of the present invention is an application program that provides an interface that enables a player to access and play the ball game. The game client 10 provides a game to the player by exchanging data with the game server 20 over the network N, and may be installed and executed in an electronic terminal, such as a personal computer (PC), a smart phone, a notebook, a personal digital assistant (PDA), or a game console. The game client 10 will be described in greater detail later.

Meanwhile, the game server 20 in accordance with this embodiment of the present invention stores a variety of types of information related to the playing of the game, such as virtual space information, game scenario information, and game quest information that form the background of the game, and detects and records various events occurring between characters controlled by the player in the virtual space, non-play characters (NPCs), and items, thereby enabling the time-series playing of the game. The game server 20 provides a game to the player by exchanging data with the game client 10 over the network N.

The game server 20 may store game account information corresponding to the game account of each player. Here, the term “game account” refers to an account that is required for the player to access the game via the game client 10, and the term “game account information” refers to player information, character information, item information or the like that is stored under the game account. The game account information may include, for example, character stance information, character level information or character item information, and may be continuously updated by the manipulation of the player or various events occurring in virtual space.

Meanwhile, the game client 10 in accordance with this embodiment of the present invention includes a game processing unit 100, and a swing management unit 110.

The game processing unit 100 in accordance with this embodiment of the present invention receives virtual space information, game scenario information, game quest information, or various event information from the game server 20, processes the information and provides the results of the processing to the player via the screen of the terminal in which the game client 10 has been installed, and receives corresponding commands of the player and transfers the commands to the game server 20.

Furthermore, the game processing unit 100 receives a variety of types of information related to a swing interface from the player or game server 20, processes the information and provides the results of the processing to the swing management unit 110 so that the swing management unit 110 can manage and handle the swing interface, receives corresponding information from the swing management unit 110, and may provide the information to the player via the screen of the terminal in which the game client has been installed or transfer the information to the game server 20. The term “swing interface” refers to an interface that provides a ball located in the virtual space of the ball game to the player so that a character can hit the ball, and may include an available hitting area for setting a hitting point, a strength icon for setting the strength value of hitting, or an impact icon for setting an impact value.

Furthermore, the game processing unit 100 may adjust the stance of the character in the virtual space based on information received from the swing management unit 110. For example, once the player has set the hitting point and the strength of hitting via the swing interface, the game processing unit 100 receives information about the hitting point and the strength of hitting from the swing management unit 110, and may adjust the stance of the character so that the character can assume the stance that enables the hitting point and the strength of hitting.

Meanwhile, the swing management unit 110 in accordance with this embodiment of the present invention manages a variety of types of information that is required to provide the swing interface. That is, the swing management unit 110 manages and processes overall information that is required to provide the swing interface that is used to hit a ball in the virtual space during the playing of the game, and may provide the results of the processing to the game processing unit 100 or provide them to the player via the screen of the terminal in which the client has been installed.

The swing management unit 110 includes a hitting point determination unit 111, a hitting strength determination unit 112, an impact determination unit 113, and a swing result processing unit 114.

The hitting point determination unit 111 in accordance with the embodiment of the present invention is configured to detect a hitting point conformable to the intention of the hitting of the player. The hitting point determination unit 111 provides an available hitting area to the player so as to detect a hitting point, and the player sets an intended hitting point via the available hitting area.

Here, the term “available hitting area” refers to an area that is used for the player to input a hitting point. If the player inputs a hitting point outside the available hitting area, the hitting point is not detected. The available hitting area may be implemented in the form of a ball that is obtained by scaling a ball in virtual space a predetermined number of times. Only a part of the ball-shaped available hitting area may be provided to the player as the available hitting area depending on the geographical information of a point in virtual space at which the ball is located. For example, in the case of a golf game, a golf ball may be located in a bunker or a hazard. Based on the fact that when a golf ball is located in a bunker, the area of the golf ball that can be hit by the player is limited, the remaining area of the ball-shaped area that is obtained by subtracting the area in the bunker from the ball-shaped area obtained by scaling the golf ball may be provided as the available hitting area.

That is, the hitting point determination unit 111 provides the available hitting area, and may set an input point as the hitting point when receiving an instruction from the player to set a point of the available hitting area as the hitting point.

Furthermore, the hitting point determination unit 111 provides the available hitting area, and may provide a rotation animation that dynamically rotates the available hitting area in accordance with a direction in which the ball is expected to be rotated based on the candidate hitting point in the available hitting area. That is, the player may set a point desired to be set as the hitting point as the candidate hitting point, and the hitting point determination unit 111 may provide a rotation animation that dynamically rotates the available hitting area in accordance with a direction in which the ball is expected to be rotated based on the candidate hitting point.

Furthermore, when the hitting point has been determined, the hitting point determination unit 111 may provide a rotation animation that dynamically rotates the available hitting area in accordance with a direction in which the ball is expected to be rotated based on the hitting point.

The rotating speed of the rotation animation may be determined by performing a simulation based on the distance between the center point of the available hitting area to the hitting point. Based on the fact that torque is proportional to the distance between the center point of the ball to a point (the hitting point) to which force is applied, the rotating speed can be increased in proportion to the distance from the center point of the available hitting area to the hitting point.

The rotation animation may be displayed until the player sets all of a hitting point, the strength value of hitting and an impact value, or may be temporarily displayed during a predetermined time.

Meanwhile, the hitting strength determination unit 112 in accordance with this embodiment of the present invention is configured to detect the strength value of hitting conformable to the intention of the hitting of the player. The hitting strength determination unit 112 provides a strength icon that enables the player to set the strength value of hitting in order to detect the strength of hitting conformable to the intention of the player, and the player may set the strength value of hitting using the strength icon.

The strength icon is implemented using a shape or the like in order to intuitively indicate the strength of hitting to the player. The strength icon may be implemented in the form of, for example, a circle or a bar.

Using the strength icon, the strength value of hitting can be indicated.

For example, a change in the color of the strength icon or the size of the strength icon may be set as a gauge, and then an increase or a decrease in the strength of hitting may be intuitively indicated to the player using a change in the filled area of the strength icon. Furthermore, an increase or a decrease in the strength of hitting may be intuitively indicated to the player using an increase or a decrease in the size of the strength icon. For example, if the radius of the strength icon corresponding to the maximum strength value of hitting is 10 cm, the radius of the strength icon corresponding to the strength value of hitting that is 50% of the maximum strength value of hitting may be 5 cm.

Although it is assumed in the following description for ease of description that the shape of the strength icon is a circle, the shape of the strength icon is not limited thereto.

The center point of the strength icon may be the same as the center point of the available hitting area. The swing interface may be represented in a brief manner by making the center point of the strength icon and the center point of the available hitting area the same.

Alternatively, the hitting strength determination unit 112 may be configured to represent and provide the strength icon using a variation animation that dynamically deforms the strength icon.

For example, the hitting strength determination unit 112 may be configured to represent and provide the strength icon using a variation animation that dynamically varies the size of the strength icon. That is, the hitting strength determination unit 112 continuously varies the size of the strength icon by providing the variation animation, and the player easily sets the strength value of hitting by stopping the operation of the variation animation when the size of the strength icon corresponds to the desired strength of hitting.

In connection with this, the variation speed of the variation animation may be determined based on the hitting stance, level, stat (for example, the class attribute of the character), mentality (which refers to mental ability and is determined based on the biorhythm of the character, game playing time, playing status, and/or the like) or item of the character. For example, the variation speed may be increased or decreased depending on the golf club that is used by a character to take a swing, or depending on the biorhythm of the character.

Furthermore, the hitting strength determination unit 112 stores the strength values of hitting corresponding to the variations of the strength icon, and thus the strength value of hitting corresponding to the size of the strength icon set by the player may be determined.

For example, the hitting strength determination unit 112 stores the strength values of hitting corresponding to the sizes of the strength icon, and thus the strength value of hitting corresponding to the size of the strength icon set by the player may be determined. Alternatively, the hitting strength determination unit 112 may set the size of the strength icon corresponding to the maximum strength value of hitting as a maximum strength guideline, acquire the strength value of hitting corresponding to the set size of the strength icon by comparing the size of the strength icon set by the player with the maximum strength guideline, and determine the acquired strength value of hitting as the strength value of hitting set by the player.

Furthermore, the hitting strength determination unit 112 may provide an animation that dynamically increases the size of the strength icon from the center point of the available hitting area up to a maximum strength guideline indicative of the maximum strength value of hitting that can be performed by a character, as the variation animation. If the player has not set the strength value of hitting, the hitting strength determination unit 112 may repeatedly provide an animation that increases the size of the strength icon.

Furthermore, the hitting strength determination unit 112 may provide at least one of the strength guidelines (which are depicted by the sizes of the strength icons) indicative of the predetermined strength values of hitting while providing the variation animation. For example, the hitting strength determination unit 112 may provide a guideline (a guideline having a radius corresponding to 50% of the radius of the maximum strength guideline corresponding to the maximum strength value of hitting) indicative of the strength value of hitting corresponding to 50% of the maximum strength value of hitting, together with the variation animation.

Meanwhile, the impact determination unit 113 in accordance with this embodiment of the present invention is configured to detect an impact value conformable to the intention of the hitting of the player. The impact determination unit 113 may provide the player with the impact icon that is used to determine impact, and the player may determine an impact value based on the set impact icon.

The impact icon is implemented using a shape or the like in order to intuitively indicate impact to the player. The impact icon may be implemented in the form of, for example, a circle or a bar. Although it is assumed in the following description for ease of description that the shape of the impact icon is a circle, the shape of the impact icon is not limited thereto.

The impact determination unit 113 may determine the impact value using the impact icon. The impact determination unit 113 may provide, for example, at least one of the impact guidelines (which are depicted by the sizes of the impact icons) indicative of predetermined impact values. And the impact determination unit 113 may determine the impact value based on the impact guideline. For example, the impact value may be acquired by computing the extent to which the impact icon is conformable to each of the impact guidelines or by computing the accuracy of the impact based on the impact guideline in which the impact icon is located.

Furthermore, the impact determination unit 113 may vary the size of the impact guideline (that is, the size of the area of the impact guideline) depending on the hitting stance, level, stat (for example, class attribute), mentality or item of the character. For example, if the level of the character is higher, the extent to which the impact icon is conformable to the impact guideline can be increased by setting the size of the impact guideline to a larger value. Based on the biorhythm of the character, the size of the impact guideline may be set to a larger value if the condition of the character is better, and to a smaller value if the condition is worse.

Furthermore, the impact determination unit 113 may represent and provide the impact icon using a variation animation that dynamically varies the impact icon.

For example, the impact determination unit 113 may represent and provide the impact icon using a variation animation that dynamically increases the size of the impact icon from the hitting point or the center point of the available hitting area and reduces the size of the impact icon over time.

The variation speed of the variation animation may be determined based on the strength value of hitting set by the player. Based on the fact that the accuracy of hitting is inversely proportional to the magnitude of backswing that is performed to increase the strength value of hitting during the playing of golf on an actual golf field, the variation speed of the size of the impact icon may be set such that it is proportional to the strength value of hitting set by the player.

Furthermore, the variation speed of the variation animation may be determined based on the hitting stance, level, stat (for example, class attribute), mentality or item of the character. For example, the reduction speed may be set to a larger value or a smaller value depending on a golf club that is used by the character to take a swing. Based on the biorhythm of the character, the variation speed may be set to a smaller value if the condition of the character is better, and to a larger value if the condition is worse.

Meanwhile, the swing result processing unit 114 in accordance with this embodiment of the present invention is configured to move a ball based on the hitting point, the strength value of hitting or the impact value set by the player. More specifically, when the swing interface that is provided to the player is a swing interface for a golf swing other than a putting swing, the swing result processing unit 114 determines the driving distance, direction of movement and amount of rotation of a ball based on the hitting point, the strength value of hitting and the impact value set by the player, and moves the ball to the determined driving distance in the determined direction of movement while rotating the ball by the determined amount of rotation. Furthermore, when the swing interface provided by the player is a swing interface for golf putting, the swing result processing unit 114 computes the distance a ball will be moved based on the strength value of hitting set by the player, and moves the ball to the computed distance.

That is, for example, the swing result processing unit 114 may determine the driving distance, direction of movement and amount of rotation of a ball based on the hitting point and the strength value of hitting set by the player if the impact value is 100%, and may determine the driving distance, direction of movement and amount of rotation of a ball based on the hitting point and the strength value of hitting, other than the hitting point and the strength value of hitting set by the player, if the impact value is significantly low.

Furthermore, the swing result processing unit 114 may adjust the strength value of hitting or the impact value set by the player based on game account information set by the player. More specifically, the swing result processing unit 114 may extract the level or stance of the character at the time at which the player is about to take a swing, or an item (for example, a golf club) which is used to take a swing, from the game account information, and adjust the strength value of hitting or the impact value based on the extracted information. For example, if the maximum strength value of hitting is limited to a predetermined value by the golf club of the character at the time at which the player is about to take a swing, the strength value of hitting may be adjusted to the predetermined value even when the strength value of hitting set by the player is larger than the predetermined value, and the driving distance of the ball may be determined based on the adjusted strength value of hitting.

Furthermore, the swing result processing unit 114 may adjust the strength value of hitting or the impact value set by the player based on geographical information in the virtual space in which a ball is located. More specifically, the swing result processing unit 114 may extract the geographical information of a ball at the time at which the player is about to takes a swing from virtual space information, and adjust the strength value of hitting or the impact value based on the extracted information. For example, if the impact value is limited to a predetermined value because a point at which a ball is placed at the time at which a player is about to take a swing is a water hazard, the impact value may be adjusted to the predetermined value even when the impact value set by the player is larger than the predetermined value, and the driving distance of the ball may be determined based on the adjusted impact value.

Furthermore, the swing result processing unit 114 may transfer the hitting point, the strength value of hitting or the impact value set by the player to the game processing unit 100 so that the stance of the character can be adjusted.

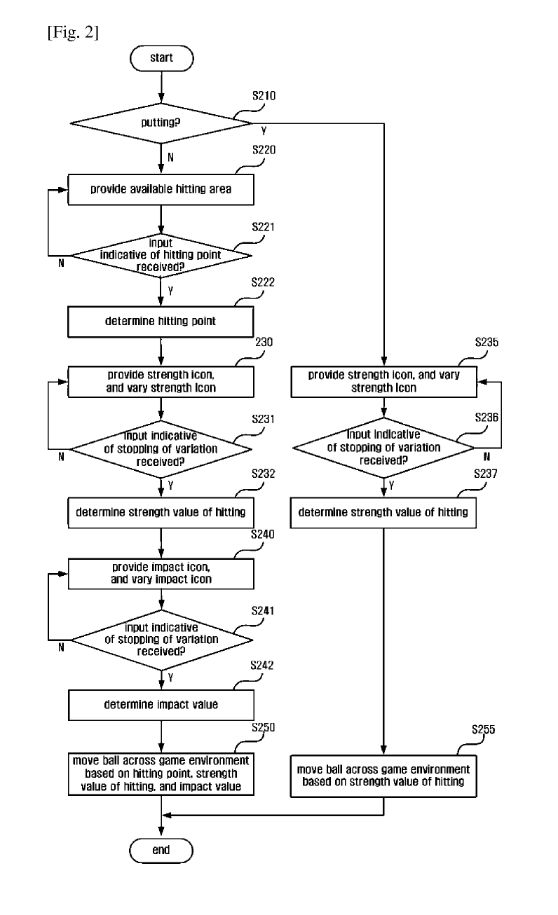

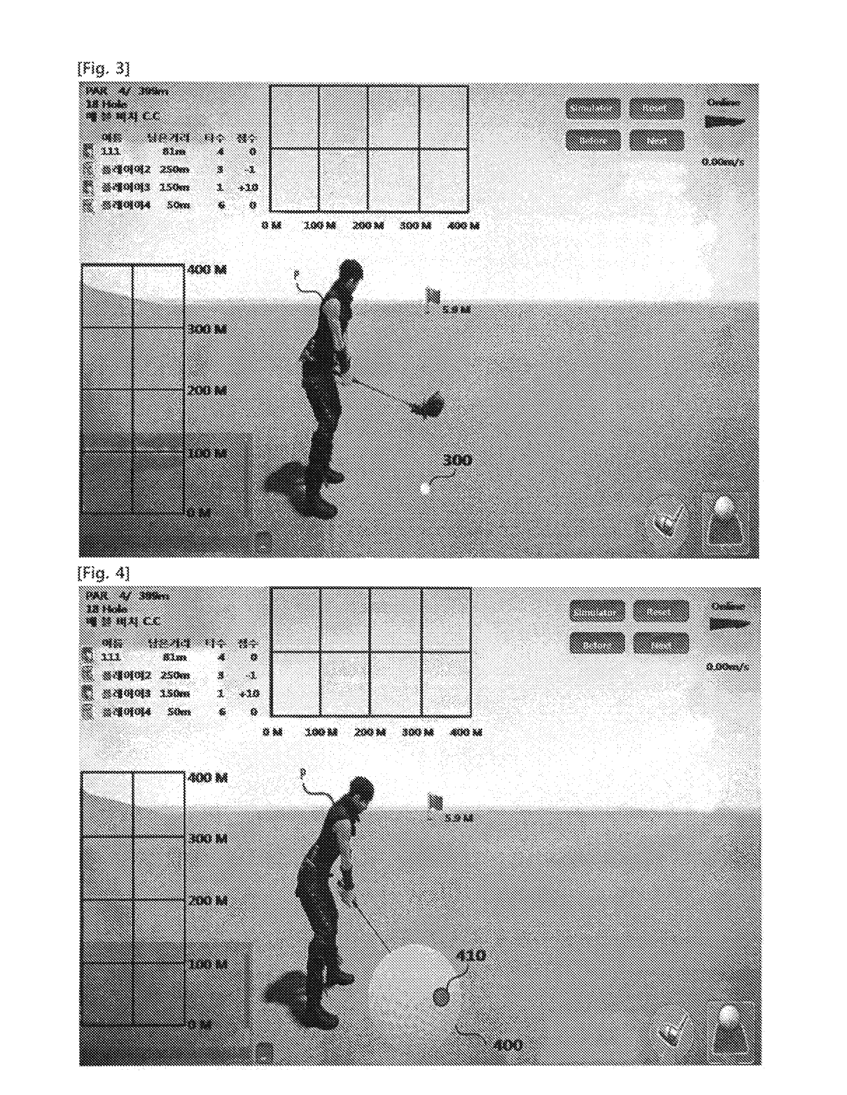

FIG. 2 is a flowchart illustrating a method of providing a ball game in accordance with an embodiment of the present invention that is performed by the system for providing a ball game. In the following description, for ease of description, it is assumed that a ball game that is provided is a golf game. FIG. 2 will be described in conjunction with FIGS. 3 to 7.

FIG. 3 is a diagram illustrating a situation prior to a swing interface being provided via the screen of a terminal in which a game client has been installed in accordance with the embodiments of the present invention.

As illustrated in FIG. 3, in order to enable a game to be played, a ball game in which a character P controlled by a player attempts to hit a golf ball 300 is provided.

Accordingly, when the player attempts to hit the golf ball 300 by controlling the character P, the swing interface for hitting is provided.

In order to provide the swing interface, it is determined whether the swing of the character intended to hit the golf ball is a putting swing at step S210. Whether the swing is a putting swing may be determined depending on a golf club that is used by the character, the distance between the golf ball and a hole cup in virtual space, or the like.

If the swing intended to hit the golf ball is not a putting swing, an available hitting area for enabling a hitting point to be input is provided at step S220, and the player may input the hitting point in the available hitting area at step S221. When a candidate hitting point is set or the hitting point is determined in the available hitting area, a rotation animation based on the hitting point or candidate hitting point may be provided.

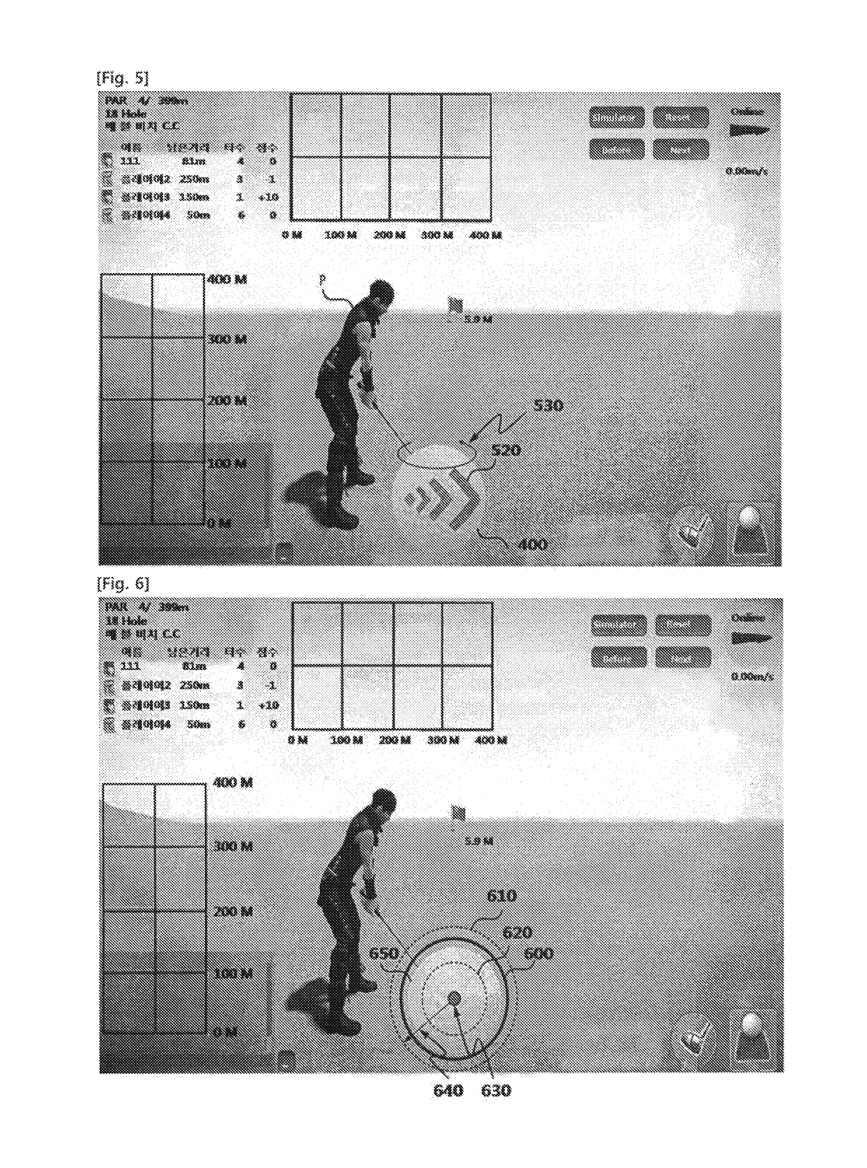

FIGS. 4 and 5 are diagrams illustrating examples of a swing interface, in particular, a swing interface for enabling the setting of a hitting point, displayed on the screen of a terminal in which a game client has been installed, in accordance with the embodiments of the present invention.

As illustrated in FIG. 4, an available hitting area 400 that is obtained by scaling the golf ball 300 of FIG. 3 a predetermined number of times is provided. Since the area that is obtained by scaling the golf ball 300 of FIG. 3 a predetermined number of times is provided as the available hitting area 400, the player can more finely set the hitting point.

Furthermore, when a point in the available hitting area 400 is set as the candidate hitting point 410 by the player, the direction of rotation 530 of the golf ball that is expected when the hitting point 410 is hit is implemented in a rotation animation and then provided, as shown in FIG. 5. The rotation animation of the golf ball may be provided along with a rotation animation in which an arrow 520 is represented in the available hitting area 400 and the arrow 520 is rotated. Even after one of the candidate hitting points has been determined, the rotation animation may be continuously provided.

Accordingly, for example, if the player points a mouse pointer at one point of the available hitting area, the point at which the mouse pointer points becomes a candidate hitting point, and the available hitting area may be displayed to the player while being dynamically rotated in the expected direction of rotation of the ball based on the candidate hitting point. Furthermore, for example, when the player points a mouse pointer at one point of the available hitting area and the mouse button is clicked, the point may be determined to be the hitting point and, in the same manner, the available hitting area may be displayed to the player while being dynamically rotated in the expected direction of rotation of the ball based on the determined hitting point.

Meanwhile, once the hitting point has been determined at step S222, the strength icon for enabling the strength of hitting of a golf ball to be determined is provided and the strength icon is varied at step S230. In this case, the strength icon may be set as a gauge, and the strength icon may be provided in the form of a variation animation that varies the filled area of the strength icon, or in the form of an animation that varies the size of the strength icon from the center point of the available hitting area. Once an input indicative of the stopping of the variation has been received at step S231, the strength corresponding to the size of the strength icon at the time at which the input indicative of the stopping of the variation is received is determined to be the strength value of hitting at step S232.

FIG. 6 is a diagram illustrating an example of a swing interface, in particular, a swing interface for enabling the setting of the strength value of hitting, displayed on the screen of a terminal in which a game client has been installed, in accordance with the embodiments of the present invention.

As shown in FIG. 6, a variation animation that provides an available hitting area 650 and dynamically increases the size of the strength icon 600 from the center point 630 of the available hitting area 650 to a maximum strength guideline 610 is provided. This enables the player to intuitively perceive the maximum strength value of hitting at the time at which the player is about to take a swing, using the maximum strength guideline 610.

Furthermore, as shown in FIG. 6, the size of the strength icon 402 is dynamically varied from the center point 630 of the available hitting area 650 to the maximum strength guideline 610 in the direction of an arrow 640, and this variation is provided to the player in the form of an animation.

Furthermore, a line 610 indicative of the size of the strength icon corresponding to 100% of the maximum strength value of hitting and a line 620 indicative of the size of the strength icon corresponding to 50% of the maximum strength value of hitting may be provided as strength guidelines. The strength guidelines 610 and 620 enable the player to clearly perceive the sizes of the strength icon corresponding to the strength values of hitting, and the player can easily set the desired strength value of hitting using the guidelines.

Accordingly, for example, when the player presses a mouse button in order to set one point of the available hitting area as the hitting point, the hitting point is set and the strength icon is displayed to the player, and then the size of the strength icon is increased from the center point of the available hitting area. When the player releases the mouse button, the release is recognized as an input indicative of the stopping of the variation of the strength icon and thus the variation is stopped, and the strength value corresponding to the size of the strength icon at the time at which the input indicative of the stopping of the variation is received may be determined to be the set strength value of hitting. In view of the fact that when golf is played on an actual golf course, the strength of hitting is generally determined based on backswing (a swing operation in which a player raises a golf club backward from a desired hitting point in order to hit a ball in golf), the provision of the swing interface that displays the strength icon and then increases the size of the strength icon when the player presses a mouse button in order to set the hitting point and that determines the strength value of hitting when the player releases the mouse button enables the player to intuitively set the strength value of hitting.

Meanwhile, after the player has set the strength value of hitting, the impact icon for enabling the player to set the impact value is provided and then the impact icon is varied at step S240. In this case, the variation in the size of the impact icon may be represented using a variation animation. If the input indicative of the stopping of the variation is received at step S241, the impact value is computed and determined based on the size of the impact icon at the time at which the input indicative of the stopping of the variation is received at step S242. For example, the accuracy of impact may be determined based on whether the size of the impact icon is present inside a specific impact guideline, and the accuracy may be determined to be the impact value.

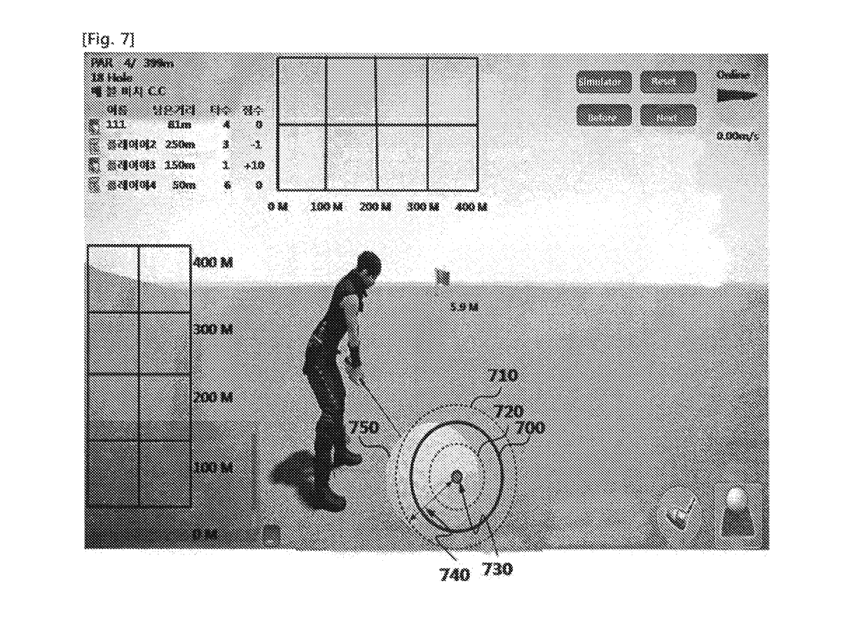

FIG. 7 is a diagram illustrating an example of a swing interface, in particular, a swing interface for enabling the setting of the impact value, displayed on the screen of a terminal in which a game client has been installed, in accordance with the embodiments of the present invention.

As shown in FIG. 7, an impact icon 700 for enabling the impact value to be set in an available hitting area 750 is provided.

Furthermore, the size of the impact icon 700 may be dynamically increased from a hitting point 730 to a maximum size impact guideline 710 in the direction of an arrow 740, and then decreased. When the variation in the size of the impact icon is stopped by the player, the impact value may be determined by comparing the size of the impact icon at the time at which the variation is stopped with a hitting point or impact guidelines 710 and 720. For example, if the size of the impact icon 700 is the same as that of the hitting point 730, the impact is determined to be just impact and thus the impact value is determined to be 100%. If the size of the impact icon 700 is located between the impact guideline 720 and the hitting point 730, the impact is determined to be normal impact and thus the impact value is determined to be 75%. In contrast, the size of the impact icon 700 is located between the impact guideline 710 and the impact guideline 720, the impact is determined to be fast/slow impact and thus the impact value is determined to be 50%.

Accordingly, for example, the player may stop the variation animation of the varying impact icon by clicking a mouse button when the impact is the desired impact. The impact value may be determined based on the size of the impact icon at the time at which the variation is stopped.

The driving distance, direction of movement and amount of rotation of a ball are determined based on the hitting point, the strength value of hitting and the impact value determined as described above, and the ball is moved to the determined driving distance while being rotated by the determined amount of rotation in the determined direction of movement at step S250.

In contrast, if the swing that the player desires to take is putting, the strength icon is provided in the form of a variation animation that varies the strength icon at step S235. For example, the strength icon may be provided in the form of a variation animation that provides an available hitting area and increases the size of the strength icon from the center point of the available hitting area.

Furthermore, if an input indicative of the stopping of the variation has been received at step S236, the strength value of hitting corresponding to the strength icon whose variation has been stopped at the time at which the input indicative of the stopping of the variation is received is determined to be the strength value of hitting at step S237. The distance the ball will be moved may be determined based on the strength value of hitting and the ball may be moved to the determined distance across a game environment at step S255.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for providing a ball game that provides a ball in virtual space and then allows the ball to be hit, comprising:
displaying an available hitting area for enabling input of a hitting point in a form of a rotation animation that dynamically rotates the available hitting area in an estimated direction of rotation of the ball based on a location of the hitting point in the available hitting area;
displaying an impact icon for enabling determination of impact in a form of a variation animation that dynamically varies the impact icon;
if an input indicative of stopping of the variation of the impact icon has been received, determining an impact value based on the impact icon whose variation has been stopped at a time at which the input indicative of the stopping of the variation of the impact icon is received; and
moving the ball across the virtual space based on the input hitting point and the impact value.

2. The method of claim 1, further comprising:
displaying a strength icon for enabling determination of a strength of hitting in a form of a variation animation that dynamically varies the strength icon; and
if an input indicative of stopping of the variation of the strength icon has been received, determining a strength value of hitting corresponding to the strength icon whose variation has been stopped at a time at which the input indicative of the stopping of the variation of the strength icon is received;
wherein moving the ball across the virtual space comprises moving the ball across the virtual space based on the input hitting point, the impact value and the strength value of hitting.

3. The method of claim 1, wherein a rotating speed of the rotation animation is determined based on a distance from a center point of the available hitting area to the hitting point.

4. The method of claim 1, wherein the available hitting area is determined based on geographical information of a point at which the ball is located in the virtual space.

5. The method of claim 1, wherein displaying the impact icon in the form of the variation animation that dynamically varies the impact icon comprises displaying the impact icon in a form of a variation animation that dynamically varies a size of the impact icon.

6. The method of claim 1, wherein displaying the impact icon in the form of the variation animation that dynamically varies the impact icon comprises displaying at least one of the impact guidelines indicative of predetermined impact values together with the variation animation of the impact icon.

7. The method of claim 6, wherein at least one of a variation speed of the variation animation of the impact icon and a size of the impact guideline is determined based on at least one of the strength value of hitting, and a hitting stance, level and item of a character.

8. The method of claim 2, wherein at least one of the strength value of hitting and the impact value is adjusted based on at least one of a hitting stance, level and item of a character and geographical information of a point at which the ball is located in the virtual space.

9. The method of claim 2, wherein displaying the strength icon in the form of a variation animation that dynamically varies the strength icon comprises displaying the strength icon in a form of an increase animation that dynamically increases a size of the strength icon to a maximum strength guideline indicative of a maximum strength value of hitting.

10. The method of claim 2, wherein displaying the strength icon in the form of a variation animation that dynamically varies the strength icon comprises displaying at least one of the strength guidelines indicative of predetermined strength values of hitting together with the variation animation of the strength icon.

11. A system for providing a ball game that provides a ball in virtual space and then allows the ball to be hit, comprising:
a hitting point determination unit configured to display an available hitting area for enabling input of a hitting point in a form of a rotation animation that dynamically rotates the available hitting area in an estimated direction of rotation of the ball based on a location of the hitting point in the available hitting area;
an impact determination unit configured to display an impact icon for enabling determination of impact in a form of a variation animation that dynamically varies the impact icon, and to, if an input indicative of stopping of the variation of the impact icon has been received, determine an impact value based on the impact icon whose variation has been stopped at a time at which the input indicative of the stopping of the variation of the impact icon is received; and a swing result processing unit configured to move the ball across the virtual space based on the input hitting point and the impact value.

12. The system of claim 11, further comprising a hitting strength determination unit configured to display a strength icon for enabling determination of a strength of hitting in a form of a variation animation that dynamically varies the strength icon, and to, if an input indicative of stopping of the variation of the strength icon has been received, determine a strength value of hitting corresponding to the strength icon whose variation has been stopped at a time at which the input indicative of the stopping of the variation of the strength icon is received;
wherein the swing result processing unit moves the ball across the virtual space based on the input hitting point, the impact value and the strength value of hitting.

13. The system of claim 11, wherein a rotating speed of the rotation animation is determined based on a distance from a center point of the available hitting area to the hitting point.

14. The system of claim 11, wherein the available hitting area is determined based on geographical information of a point at which the ball is located in the virtual space.

15. The system of claim 11, wherein the impact determination unit displays the impact icon in a form of a variation animation that dynamically varies a size of the impact icon.

16. The system of claim 11, wherein the impact determination unit displays at least one of the impact guidelines indicative of predetermined impact values together with the variation animation of the impact icon.

17. The system of claim 16, wherein at least one of a variation speed of the variation animation of the impact icon and a size of the impact guideline is determined based on at least one of the strength value of hitting, and a hitting stance, level and item of a character.

18. The system of claim 12, wherein at least one of the strength value of hitting and the impact value is adjusted based on at least one of a hitting stance, level and item of a character and geographical information of a point at which the ball is located in the virtual space.

19. The system of claim 12, wherein the hitting strength determination unit displays the strength icon in a form of an increase animation that dynamically increases a size of the strength icon to a maximum strength guideline indicative of a maximum strength value of hitting. displays at least one of the strength guidelines indicative of predetermined strength values of hitting together with the variation animation of the strength icon.
